(19) United States
(12) Patent Application Publication
(10) Pub. No.: US 2014/0039364 A1
(43) Pub. Date: Feb. 6, 2014

(54) Massage Device with Handle and Textured Object on Cord

(71) Applicant: Dylan Quinn Jawahir, San Diego, CA (US)

(72) Inventor: Dylan Quinn Jawahir, San Diego, CA (US)

(21) Appl. No.: 13/566,601

(22) Filed: Aug. 3, 2012

(51) Int. Cl. A61H 7/00

(52) U.S. Cl. CPC A61H 7/001
USPC 601/137

(57) ABSTRACT

A hand held massage device comprised of a handle (101), cord (102), and a textured object (104). Handle (101) is fixed to an end of cord (102) with textured object (104) fixed to the opposite end of cord (102). Both the handle (101) and textured object (104) can be used to apply therapeutic massage, with the handle providing manual massage stimulation to areas of the body within arm's length, while the textured object (104) provides massage stimulation to other, more difficult to reach parts of the body. The textured object (104) provides traction on fabric and conventional flooring materials which gives the user greater control during placement and use of the massage device on a variety of surface types. The design of the massage device is simple, cost-effective, and allows the user to massage his or her body on a plethora of surfaces and in a multitude of body positions.

### CROSS-REFERENCE TO RELATED APPLICATIONS

None.

### FIELD OF THE INVENTION

The present invention relates to therapeutic massage devices and more specifically to a hand held massage devices.

### BACKGROUND OF THE INVENTION

Massage therapy is a beneficial, non-invasive medical treatment for the body. It is used to address soft tissue ailments and issues such as, but not limited to, muscle trigger points, muscle strains, tendon sprains, and scar adhesion. The wide array of massage therapy techniques do much to improve circulation, increase range of motion, reduce pain, etc. These techniques are best performed by a professional massage therapist. But, there are other ways of getting effective massage without some of the limitations finding a massage therapist presents. Thus, an abundance of self massage therapy devices have been created for convenience and use when one lacks time, money, and/or skill in massage therapy techniques. Plenty of self massage therapy devices are available in the marketplace. Many of the designs can be intimidating to a buyer. Existing self massage therapy devices suffer from a list of disadvantages, such as:
a) Complicated to manufacture.
b) Requires a substantial number of parts to create.
c) Requires external power supply.
d) Requires significant joint range of motion from the user to align or utilize.
e) Requires more than one hand to facilitate usage.
f) Requires another person to assist in locating and securing device in place for use.
g) Function and use is limited to certain parts of the body.
h) Lack the pressure necessary for therapeutic effect.
i) Complicated to use.

### SUMMARY

In accordance with one embodiment, a massage device with handle and textured object on cord remedies the disadvantages stated above for currently existing massage devices. The embodiment presents an elegantly simple, versatile, and improved self-massage tool, which address the limitations of other massage devices.

One embodiment comprises at minimum three parts: a handle, a cord, and a textured object in the form of a rubber ball. The embodiment presents a durable massage apparatus with two effective components for which to massage the body. The handle can be used to manually stimulate massage trigger points within arm's reach. Precise, focused massage can be performed using the handle which strongly supports the hand and fingers during self massage techniques. The other massage component, the textured object, is a compressible substance of conventional or unconventional shape. Using the handle and cord, the textured object can be placed and secured between the user and a planar surface of inclination between 0 and 90 degrees. Massage pressure can be modulated over the textured object with the user's body weight. The textured object can be sandwiched between the user and a variety of surfaces, including but not limited to, a wall or floor. Examples of other embodiments of the textured object are, but not limited to, a knobbed sphere, a ribbed cylinder, and a double ball. Additionally, the textured object can be relocated anywhere along the cord for versatility in use. The embodiment is intuitive to use, effective for therapeutic self massage, and requires only one hand to operate.

### ADVANTAGES

Accordingly, several advantages of one or more aspects are as follows:
a) Easy to manufacture
b) Few parts to construct
c) No batteries or external power supply necessary
d) Handle and cord act as an extension of the arm
e) One handed operation
f) Easily controlled by user
g) Effective on major muscle groups
h) Therapeutic massage pressure can be modulated through a combination of body weight, direct force, and gravity
i) Intuitive design

Additional advantages will be a durable, versatile, cost-effective massage therapy device to treat the major musculature of the body. The simple design and low cost of the massage device will allow it to be used by a broad demographic. The self modulated massage pressure allows anyone from a sedentary person to a world-class athlete to customize the therapeutic massage they need at their own convenience. Other advantages of one or more aspects will be apparent from a consideration of the drawings and ensuing description.

### BRIEF DESCRIPTION OF DRAWINGS

FIG. 1 shows aspects of one embodiment of the massage device with handle and textured object on cord.

FIG. 2 shows common massage trigger points in the buttocks region of the body.

FIG. 3 is a perspective view of a person using the embodiment while lying down on a horizontal surface.

FIG. 4 shows common massage trigger points in the back region of the body.

FIG. 5 is a perspective view of a person using the embodiment while leaning against a vertical surface.

FIG. 6 is a perspective view of a person using the embodiment while sitting.

FIG. 7 is a perspective view of a sitting person using the embodiment and leaning against a vertical surface.

FIG. 8 is an alternate embodiment of the massage device using a knobby ball.

FIG. 9 is an alternate embodiment of the massage device using a double ball.

FIG. 10 is an alternate embodiment of the massage device using a grooved cylinder. This figure includes a sectional view of the grooved cylinder.

FIG. 11 is an alternate embodiment of the massage device using an octagonal cylinder. This figure includes a sectional view of the octagonal cylinder.

### DETAILED DESCRIPTION

### First Embodiment

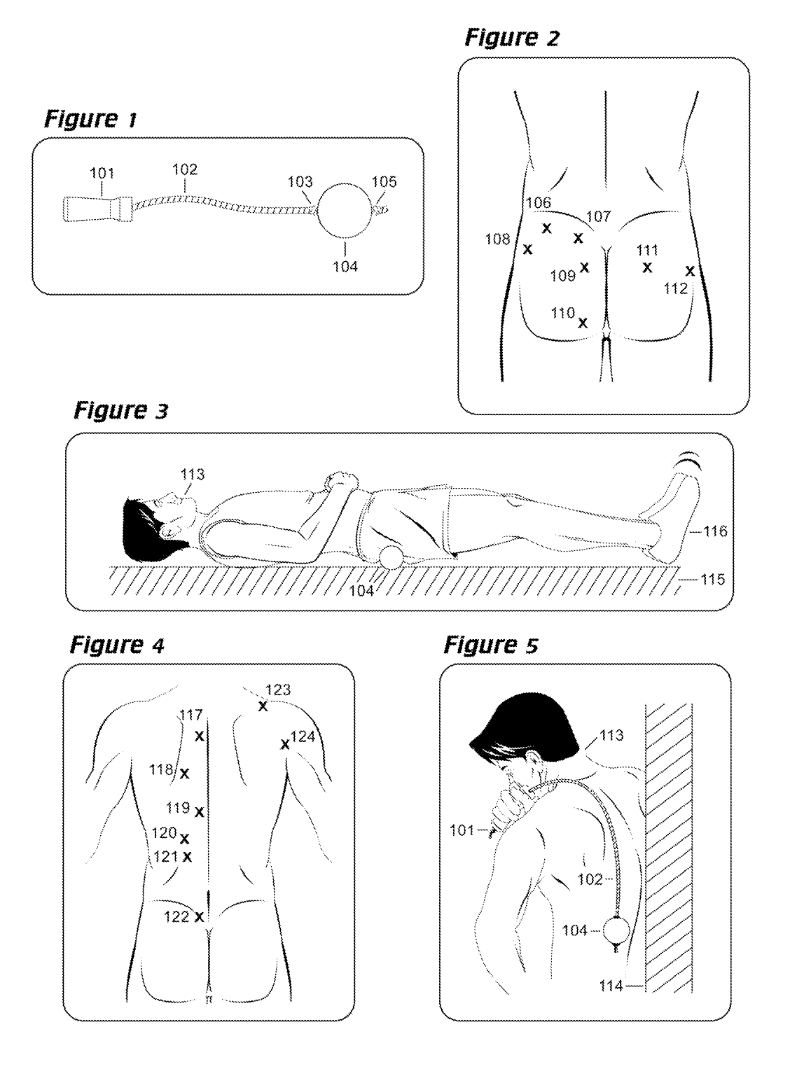

### FIG. 1 Description

One embodiment of a massage device with handle and textured object on cord is illustrated in FIG. 1. The handle 101 is affixed to an end of cord 102. In one embodiment, handle 101 is wood. However, handle 101 can consist of any other material such as steel, plastic, rubber, etc. that can be grasped with a hand. Handle 101 can be shaped such that it supports the fingers and hand for manual massage therapy. Handle 101 can also be shaped such that a portion of said handle 101 can be applied directly for massage.

Cord 102 is flexible and in one embodiment, cord 102 consists of braided polypropylene strands. However, cord 102 can consist of any other material such as steel cable, wire braid, nylon, leather, various fibrous materials, etc.

The fasteners 103 and 105 are affixed to cord 102 and secure textured object 104. In one embodiment, fasteners 103 and 105 are knots in cord 102. However, fasteners can consist of any other material such as metal, plastic, wood, etc. which can secure textured object 104 in place along cord 102. In one embodiment, fasteners 103 and 105 are permanently fixed along cord 102. However, fasteners can be temporarily attached to cord 102 to provide placement of textured object 104 in an infinite number of locations along cord 102.

Textured object 104 is a three-dimensional form affixed along cord 102. In one embodiment, textured object 104 is allowed axial rotation along cord 102. However, other embodiments may not allow axial rotation. In one embodiment, textured object 104 is made from natural rubber. However, textured object 104 can consist of metal, wood, polyurethane, etc. which provides a specified amount of resistance to compression. Along with a textured spherical shape of object 104, other embodiments can include a knobby ball 126, double ball 127, grooved cylinder 128, octagonal cylinder 129, etc. to provide various surface structures for massage trigger point stimulation. Object 104 can be of a shape, including but not limited to, a cylinder, cube, cone, polyhedron, etc. to provide various edges and surfaces for massage.

### FIGS. 2 and 4 Description

FIGS. 2 and 4 show typical massage trigger points that can be treated using one embodiment of the massage device. The massage trigger points 106-112 shown in FIG. 2 are part of the gluteal muscle group of the body and are often used to relieve sciatic and hip pain. The massage trigger points 117-124 shown in FIG. 4 are part of the back muscle group of the body and are used to relieve back pain and shoulder pain. The massage device is not limited to the massage points shown in FIGS. 2 and 4, but can be used on any part of the body to provide pain relief.

### Operation—FIGS. 3, 5, 6, and 7

FIGS. 3,5,6 and 7 illustrate the massage device being used in multiple body positions and orientations to facilitate massage trigger point stimulation to the person 113.

In FIG. 3, person 113 is lying supine on a horizontal surface. Textured object 104 is placed between person 113 and a horizontal surface 115 with massage device located underneath one of the body massage points 106-112. In this position, person 113 may internally and externally rotate the ipsilateral hip to produce a dynamic massage stimulation of the area over the massage device.

In FIG. 5, person 113 is leaning against a vertical surface 114 where handle 101 and cord 102 is used to position textured object 104 between said person and vertical surface 114. The position of textured object 104 may be upon one of body massage points 117-124 or any other part of the back. In this position, person 113 may shift from side to side to produce a dynamic massage stimulation of the area over the massage device.

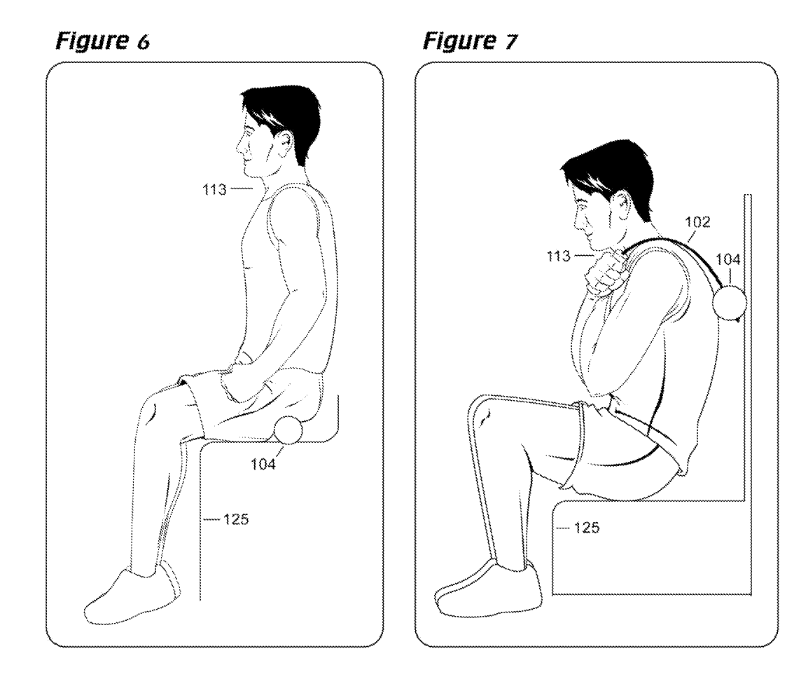

In FIG. 6, person 113 is in a sitting position on a chair 125. Textured object 104 is sandwiched between the gluteus muscles of person 113 and the horizontal portion of the chair 125. The right hand (not shown) of person 113 may be used to hold handle 101 and secure textured object 113 from sliding about under pressure.

In FIG. 7, person 113 is in a sitting position on a chair 125. Textured object 104 is placed between person 113 and the vertical portion of the chair 125. Textured object 104 can be positioned on a massage trigger point using handle 101 and cord 102 of the massage device. In this FIG. 7, person 113 can place textured object 104 on massage points 117-124 or on any other part of the back. Person 113 can lean into textured object 104 for deeper pressure or rock back and forth over textured object 104 for dynamic massage stimulation.

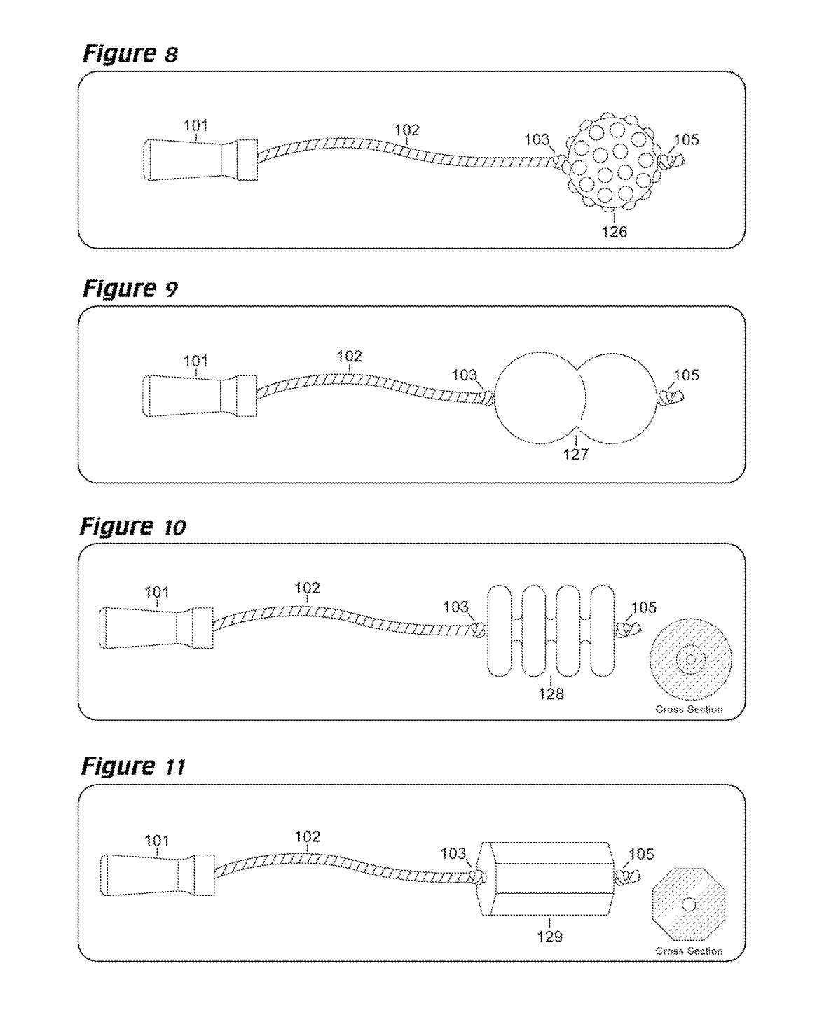

### FIGS. 8-11 Additional Embodiments Description

FIGS. 8-11 comprise other embodiments of the massage device. Textured object 104 from FIG. 1 is replaced with other massage device components with varying surface features, such as 126-129 in FIGS. 8-11. The surface features of components 126-129 provide different types of stimulation when applied to the body. The skin, as well as underlying muscle and fascia will respond accordingly to the contours and shape of each individual component 126-129. This response can be in the form of blood, lymphatic and other circulatory fluid flow changes in the body.

### Additional Embodiments

Additional embodiments include various handle 101 shapes. Handle 101 can be shaped with a lathe or other method to introduce various curves and features that are more or less ergonomic. Other embodiments of handle 101 can allow said handle to be used to massage areas of the body.

Additional embodiments of cord 102 can consist of various materials, such as cable, twine, etc. which may alter the flexibility of the massage device.

Additional embodiments of textured object 104 are shown in FIG. 8-11. These include, but are not limited to knobby ball 126, double ball 127, grooved cylinder 128, and octagonal cylinder 129. Also, textured object 104 and additional embodiments can consist of material which can be heated or cooled and then applied to the target area on the body. Textured object 104 and additional embodiments may also consist of an energy-driven vibratory device to stimulate target areas on the body.

Although the additional embodiments described above contain many specificities, these should not be construed as limiting the scope of the embodiments, but as merely providing illustrations of several embodiments of the massage device.

Thus the scope of the embodiments should be determined by the appended claims and their legal equivalents, rather than by the examples given.

### DRAWING REFERENCE NUMERALS

101 Handle

102 Cord

103 Fastener

104 Textured Object

105 Fastener

106-112 Body Massage Trigger Point

113 Person

114 Wall

115 Level surface

116 Foot

117-124 Back Massage Trigger Point

125 Chair

126 Knobby Ball

127 Double Ball

128 Grooved Cylinder

129 Octagonal Cylinder

We claim:

1. A massage device comprising a cord linking at least one handle and at least one compressible textured object.

2. The massage device of claim 1 wherein said handle is composed of wood.

3. The massage device of claim 1 wherein said handle is shaped to support the hand in applying therapeutic massage stimulation to a particular area of the body.

4. The massage device of claim 1 wherein said handle is used to aid positioning and securing the compressible textured object between a person and a planar surface for therapeutic use.

5. The compressible textured object attached to a cord in some fashion, that is used to:
provide a three-dimensional surface for which a user can apply body weight or physical pressure to, for therapeutic purposes.
heat or cool skin and substructures during contact with the textured object.
apply vibrating or oscillating pressure to skin and substructures of a person during contact with the textured object.

6. A method of therapeutic massage, comprising sandwiching said massage device between a person and planar surface of varying slope whereby user will be gain additional reach, ease of positioning, and ease of securing such massage device between said user and a planar surface.
